(19) United States
(12) Patent Application Publication
(10) Pub. No.: US 2013/0162419 A1
(43) Pub. Date: Jun. 27, 2013

(54) FORCE FEEDBACK DEVICE

(71) Applicants: Yu-Ming CHANG, Taoyuan County (TW); Jen-Chen WU, Taoyuan County (TW)

(72) Inventors: Yu-Ming CHANG, Taoyuan County (TW); Jen-Chen WU, Taoyuan County (TW)

(73) Assignee: QUANTA STORAGE INC., Taoyuan County (TW)

(21) Appl. No.: 13/603,306

(22) Filed: Sep. 4, 2012

(30) Foreign Application Priority Data
Dec. 27, 2011 (CN) 201110443483.9

(51) Int. Cl. G08B 6/00

(52) U.S. Cl. 340/407.2

(57) ABSTRACT

A force feedback device is provided. Several spring-sleeved screw bolts respectively pass through the suppression holes around the top cover to fix the top cover on the base. Each spring in the ladder-shaped suppression hole is suppressed between the nut of the screw bolt and the top cover. Since the body of the screw bolt is longer than a predetermined height of the suppression hole, an absorption gap is reserved between the nut and the top cover to provide a smooth feel in operating the joystick.

This application claims the benefit of People's Republic of China application Serial No. 201110443483.9, filed Dec. 27, 2011, the subject matter of which is incorporated herein by reference.

### BACKGROUND OF THE INVENTION

1. Field of the Invention

The invention relates in general to a force feedback device, and more particularly to a joystick operating a multi-axial control input interface for games or vehicles.

2. Description of the Related Art

The force feedback device mainly uses a joystick to achieve multi-axial displacement, and precise movement control and smooth operating feel are required for moving an object to a predetermined position.

Referring to FIG. 1, a force feedback device 10 according to the prior art is disclosed in the U.S. Pat. No. 4,733,214. A slot 12 surrounded by several sensors 13 is formed on a base 11. A sphere 14 whose outer diameter matches with the shape of the slot 12 is disposed in the slot 12 and covered by a top cover 15. The top cover 15 has a mask 16 whose center has an operating hole 17. The inner side of the mask 16 matches with the outer diameter of the sphere 14. The screw bolt 18 fixes the top cover 15 on the base 11, such that the slot 12 of the base 11 in conjunction with the mask 16 of the top cover 15 support the sphere 14 to rotate. The joystick 19 passes through the operating hole 17 of the top cover 15 to be connected to the sphere 14, and drives the sphere 14 to rotate. The sensors 13 detect the displacement of the sphere 14 and transmit the operating displacement of the joystick 19 for controlling the movement of an object.

However, in the force feedback device 10 of the prior art, the slot 12 and the mask 16 envelop the sphere 14 and support the sphere 14 to rotate. Due to the difficulty in achieving true roundness and the manufacturing tolerance, after assembly, the gap between the sphere 14 and the slot 12 and the mask 16 may be too loose or too tight. When the gap is too loose, the sphere 14 cannot be precisely positioned, and the precision in the displacement of the joystick 19 is reduced. When the gap is too tight, the sphere 14 cannot slide easily, and the operating feel of the joystick 19 is affected. Particularly, the above problems are even worse for the force feedback device requiring multi-axial control and using multi-layered axial stacking. Therefore, the force feedback device still has many issues to resolve in terms of assembly structure.

### SUMMARY OF THE INVENTION

The invention is directed to a force feedback device. An absorption gap is reserved between the screw bolt and the top cover, and the screw bolt is sleeved with a spring for absorbing assembly tolerance so as to increase control precision and operating smoothness.

According to an embodiment of the present invention, a force feedback device is provided. The base has a slot surrounded by several screw holes. The shaft unit comprises at least one axis rod. One end of each axis rod has a force feedback connector. The middle section of each axis rod has an arc rod. The center of the arc rod has a displacement slot along the long axis direction of the axis rod, and the axis rod is rotated and mounted across the slot of the base. The number of feedback mechanisms of the force feedback unit corresponds to the number of axis rods. Each force feedback mechanism has a step motor connected to the force feedback connector of the axis rod through a gear set. The step motor provides a power for detecting the displacement of the axis rod and driving the force feedback mechanism. The mask protruded from the top cover has an operating hole surrounded by several suppression holes. The joystick passes through the displacement slot of the axis rod via the operating hole of the top cover to be linked to the slot in a multi-directional and movable manner. The number of screw bolts corresponds to the number of suppression holes. Each screw bolt sequentially having a nut, a body and a thread portion is sleeved with a spring and passes through a suppression hole to fix the thread portion in the screw hole of the base, and the nut presses the spring to stay in the suppression hole. An absorption gap is reserved between the nut and the top cover as the body is longer than a predetermined height of the suppression hole.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a force feedback device according to the prior art;

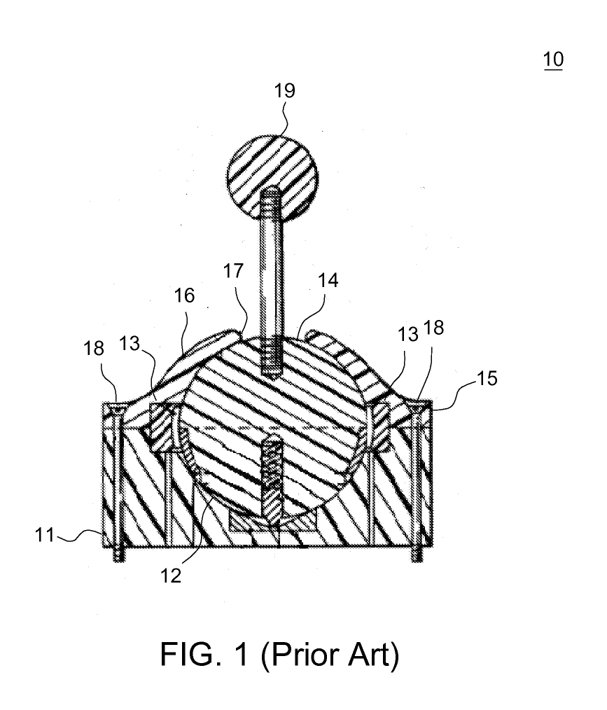

FIG. 2 shows a 3D diagram of a force feedback device according to a first embodiment of the invention;

FIG. 3 shows an explosion diagram of the parts of a force feedback device according to a first embodiment of the invention;

FIG. 4 shows a side cross-sectional view of a force feedback device according to a first embodiment of the invention;

FIG. 5 shows a partial side cross-sectional view of a screw bolt combined with a suppression hole according to a first embodiment of the invention; and

FIG. 6 shows side cross-sectional view of a force feedback device according to a second embodiment of the invention.

### DETAILED DESCRIPTION OF THE INVENTION

The technologies of the invention for achieving the above objects and the effects of the technologies are elaborated below in exemplary embodiments with accompanying drawings.

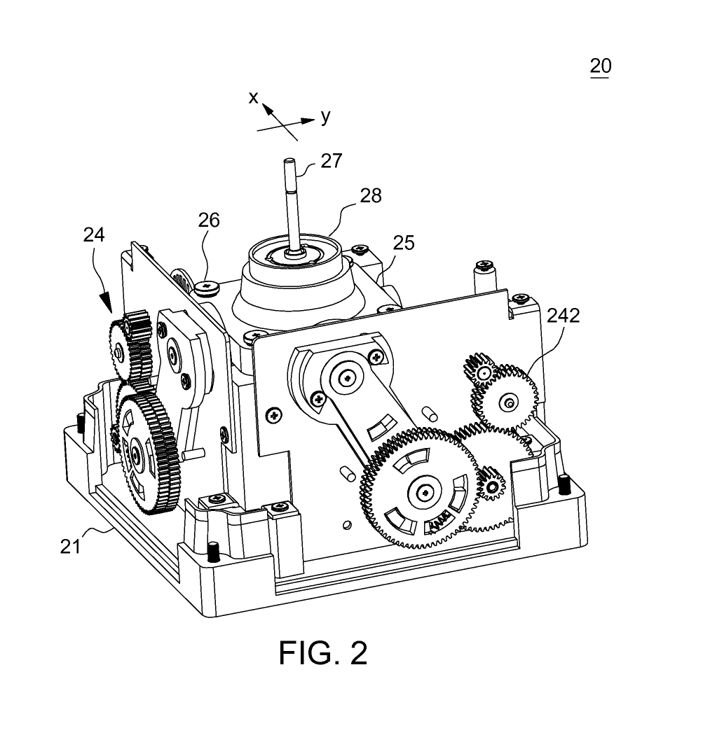

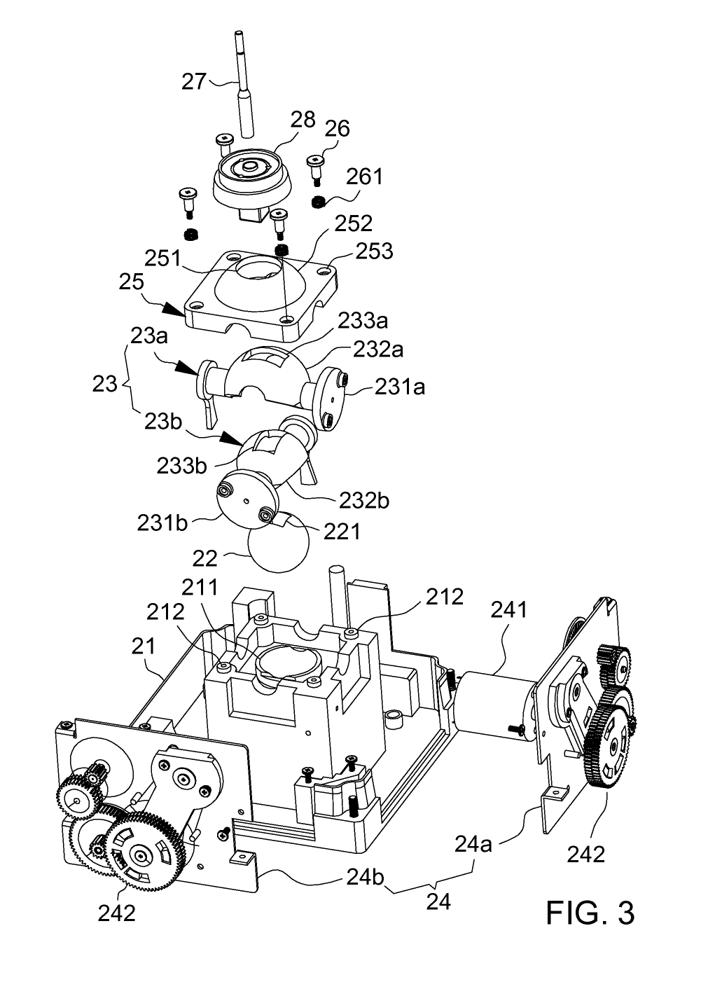

Referring to FIG. 2 and FIG. 3. FIG. 2 shows a 3D diagram of a force feedback device 20 according to a first embodiment of the invention. FIG. 3 shows an explosion diagram of the parts of a force feedback device 20 according to a first embodiment of the invention. The force feedback device 20 mainly comprises a base 21, a sphere 22, a shaft unit 23, a force feedback unit 24, a top cover 25, a screw bolt 26 and a joystick 27. The base 21 has a slot 211 surrounded by several screw holes 212. The sphere 22 rotates in the slot 211, and has a joint hole 221.

The shaft unit 23 comprises at least one axis rod, and the number of axis rods is determined according to the number of control axes of the force feedback device 20. In the present embodiment, the control axes are exemplified by X axis and Y axis, that is, the shaft unit 23 comprises an X-axis rod 23a and a Y-axis rod 23b. The X-axis rod 23a and the Y-axis rod 23b respectively have force feedback connectors 231a and 231b at one end, and arc rods 232a and 232b in the middle section. The centers of the arc rods 232a and 232b have displacement slots 233a and 233b along the long axis direction of respective axis rod, and each axis rod may be rotated and mounted across the slot 211 of the base 21a according to the direction of control axes. The arc rods 232a and 232b are stacked on the sphere 22. In the present embodiment, the Y-axis rod 23b is at the bottom layer and the X-axis rod 23a is at the top layer, such that the arc rod 232b of the Y-axis rod 23b at the bottom layer matches with the outer diameter of the sphere 22 and cover the sphere 22, and the outer diameter of the arc rod 232a of the X-axis rod 23a at the top layer matches with the arc rod 232b of the Y-axis rod 23b at the bottom layer and covers the arc rod 232b at the bottom layer.

The number of force feedback mechanisms of the force feedback unit 24 corresponds to the number of axis rods of the shaft unit 23. In the present embodiment, the control axes are exemplified by the X axis and the Y axis, that is, the force feedback unit 24 comprises an X-axis force feedback mechanism 24a and a Y-axis force feedback mechanism 24b. Each force feedback mechanism has a step motor 241 respectively connected to the force feedback connector 231a of the X-axis rod 23a and the force feedback connector 231b of Y-axis rod 23b through a gear set 242. The step motor provides a power for detecting the displacement of the axis rod and driving the force feedback mechanism.

The top cover 25 has a mask 251 whose center has an operating hole 252 surrounded by several suppression holes 253. The inner side of the mask 251 matches with the outer diameter of the arc rod 232a and covers the X-axis rod 23a at the top layer. The number of screw bolts 26 corresponds to the number of suppression holes 253. Each screw bolt 26 is sleeved with a spring 261 and passes through the suppression hole 253 to fix the thread portion in the screw hole 212 of the base 21 and fix the top cover 25 on the base 21. Besides, the joystick 27 passes through each displacement slot of the axis rod 233 via the operating hole 252 of the top cover 25 to be connected to the joint hole 221 of the sphere 22. In addition, the operating hole 252 of the top cover 25 may be covered with a sleeve 28 mounted on the joystick 27 to avoid external objects entering the operating hole 252 of the top cover 25 and affecting the operation of the joystick 27.

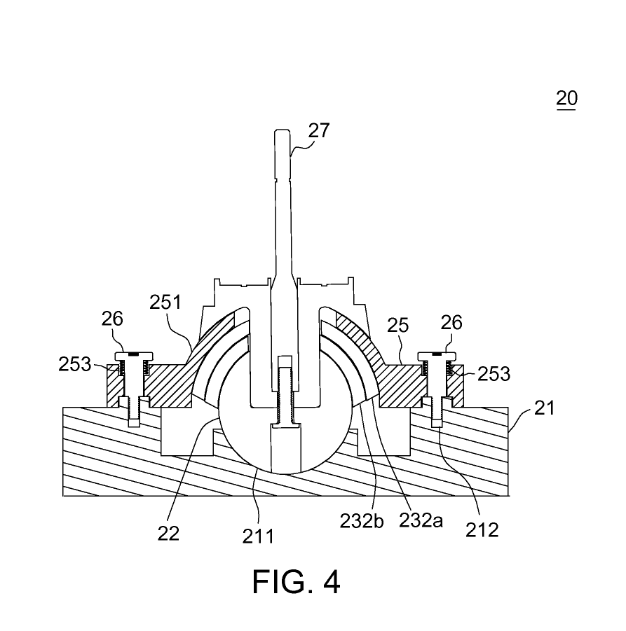

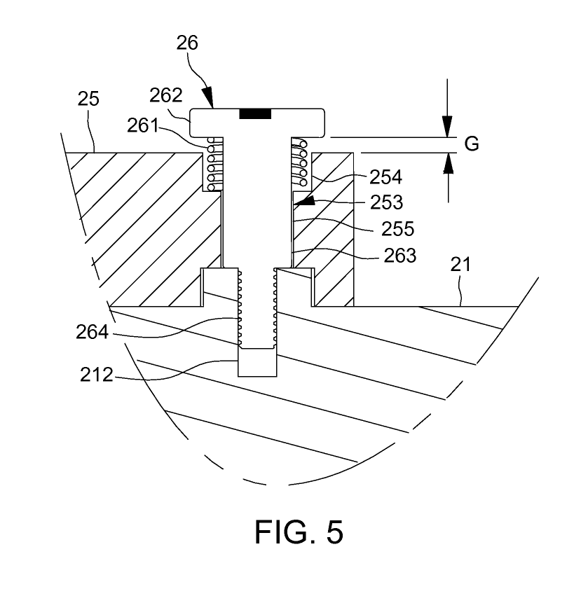

Referring to FIG. 4 and FIG. 5. FIG. 4 shows a side cross-sectional view of a force feedback device 20 according to a first embodiment of the invention. FIG. 5 shows a partial side cross-sectional view of a screw bolt 26 combined with a suppression hole 253 according to a first embodiment of the invention. In the force feedback device 20, when the screw bolt 26 fixes the top cover 25 on the base 21, the mask 251 of the top cover 25 sequentially suppresses the arc rod 232a of the X-axis rod, the arc rod 232b of the Y-axis rod and the sphere 22 such that the sphere 22 is indented into the slot 211 to form a stacking state. The joystick 27 is fixed in the joint hole 221 of the sphere 22, and the sphere 22 is indented into and rotates in the slot 211, such that the joystick 27 may move in multi-directions to push respective displacement slots 233a and 233b of the axis rods, and slides on the curvature of the arc rods 232a and 232b to move the axis rods.

To avoid the gap, formed when the mask 251, each of the arc rods 232a and 232b, the sphere 22 and the slot 211 are stacked, becoming too loose or too tight after assembly, in the force feedback device 20 of the present embodiment, the suppression hole 253 of the top cover 25 forms a ladder-shaped slot having at least two stages, that is, a first ladder portion 254 and a second ladder portion 255, wherein the outer diameter of the first ladder portion 254 is larger than that of the second ladder portion 255 for accommodating the spring 261. Then, the screw bolt 26 sequentially has three stages of ladder-shaped outer diameters for the nut 262, the body 263 and the thread portion 264 arranged from large to small diameters. The outer diameter of the nut 262 is larger than that of the spring 261. The body 263 may pass through the spring 261 and the second ladder portion 255. The height of the body 263 is longer than a predetermined height of the suppression hole 253. Thus, the screw bolt 26, sleeved with a springs 261, passes through the suppression hole 253 to fix the thread portion 264 in the screw hole 212 of the base 21, the nut 262 presses the spring 261 to stay in the first ladder portion 254 of the two-stage ladder-shaped suppression hole 253 and suppresses the second ladder portion 255 to hold the top cover 25. The body 263 is longer than a predetermined height of the suppression hole 253, such that an absorption gap G is reserved between the nut 262 and the top cover 25.

The absorption gap G reserved between the nut 262 and the top cover 25 absorbs the gap formed when the mask 251, each of the arc rods 232a and 232b, the sphere 22 and the slot 211 are stacked together. When the gap is too loose, the top cover 25 is suppressed by the spring 261, such that the gap of the stacking piece is reduced and the precision in the displacement of the joystick 27 is increased. Conversely, when the stacking is too tight, the top cover 25 suppresses the spring 261 to move in the absorption gap G and reserve an adjustment space when the stacking is too tight so as to provide smooth feel in operating the joystick 27. Meanwhile, the reserved absorption gap G provides the force feedback device with larger manufacturing tolerance, not only reducing the manufacturing cost but also reducing the difficulty in achieving stacking true roundness.

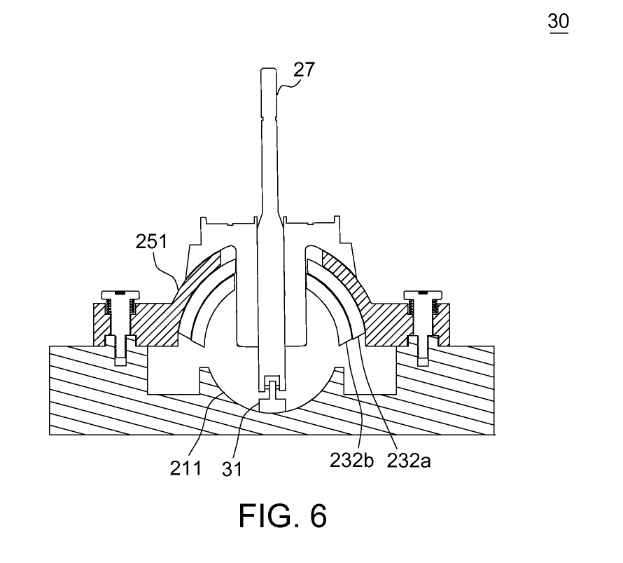

Referring to FIG. 6, a side cross-sectional view of a force feedback device 30 according to a second embodiment of the invention is shown. The basic structures of the force feedback device 30 of the second embodiment are the same with that of the force feedback device 20 of the first embodiment. The components common to the first embodiment and the second embodiment retain the same numeric designation. The difference between the first and second embodiments mainly lies in that the force feedback device 30 of the second embodiment simplifies the sphere of the force feedback device of the first embodiment, such that the joystick 27 may be linked to the slot 211 in a multi-directional and movable manner by a linking device 31 to reduce the sliding resistance of multi-layer stacking between the mask 251 and each of the arc rods 232a and 232b. In the present embodiment, the linking device 31 is exemplified by a Cardan shaft but the invention is not limited thereto. For example, the multi-directional and movable link may be realized in the first embodiment if the slot 211 is not filled with small diameter spheres.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A force feedback device, comprising:
a base having a slot surrounded by a plurality of screw holes;
a shaft unit comprising at least one axis rod, wherein one end of each axis rod has a force feedback connector, the middle section of each axis rod has an arc rod, the center of the arc rod has a displacement slot along a long axis direction of the axis rod, and each axis rod is rotated and mounted across the slot of the base;
a force feedback unit having a plurality of force feedback mechanisms each having a step motor connected to the force feedback connector of the axis rod through a gear set, wherein the step motor provides a power for detecting the displacement of the axis rod and driving the force feedback mechanisms;
a top cover having a mask, wherein the mask has an operating hole surrounded by a plurality of suppression holes;
a joystick passing through the displacement slot of the axis rod via the operating hole of the top cover to be linked to the slot in a multi-directional and movable manner; and
a plurality of screw bolts whose number corresponds to the number of suppression holes, wherein each screw bolt sequentially has a nut, a body and a thread portion and is sleeved with a spring;
wherein, each spring-sleeved screw bolt passes through the suppression hole to fix the thread portion in the screw hole of the base, the nut presses the spring to stay in the suppression hole, and an absorption gap is reserved between the nut and the top cover as the body is longer than a predetermined height of the suppression hole.

2. The force feedback device according to claim 1, wherein the shaft unit comprises two control rods, that is, an X-axis rod and a Y-axis rod, and the arc rods of the axis rods are stacked along respective axial directions of the control rods.

3. The force feedback device according to claim 1, wherein the suppression hole comprises ladder-shaped slot having at least two stages, namely, a first ladder portion and a second ladder portion, and an outer diameter of the first ladder portion is larger than that of the second ladder portion for accommodating the spring.

4. The force feedback device according to claim 3, wherein the screw bolt has three stages of ladder-shaped outer diameters for a nut, a body and a thread portion of the screw bolt sequentially arranged from large to small outer diameters.

5. The force feedback device according to claim 4, wherein the outer diameter of the nut is larger than that of the spring, and the body passes through the spring and the second ladder portion.

6. The force feedback device according to claim 5, wherein the nut presses the spring to stay in the first ladder portion of the suppression hole and suppresses the second ladder portion to hold the top cover.

7. The force feedback device according to claim 1, wherein the sphere rotates in the slot and has a joint hole for linking the joystick, the mask of the top cover covers the arc rod, and the sphere and the slot form a stacking piece.

8. The force feedback device according to claim 1, wherein the top cover is suppressed by the spring to reduce a gap of the stacking piece when the gap of the stacking piece is too loose, and the top cover suppresses the spring to move in an absorption gap when the gap of the stacking piece is too tight.

9. The force feedback device according to claim 1, wherein the joystick is linked to the slot by a Cardan shaft.
